(19) United States
(12) Patent Application Publication
(10) Pub. No.: US 2012/0259688 A1
(43) Pub. Date: Oct. 11, 2012

(54) SYSTEM AND METHOD FOR SELLING AND OPERATING HOTEL ROOMS

(76) Inventor: Eunsoon Kim, Seoul (KR)

(21) Appl. No.: 13/516,862

(22) PCT Filed: Dec. 6, 2010
(86) PCT No.: PCT/KR2010/008659

§ 371 Date: Jun. 18, 2012

(30) Foreign Application Priority Data
Dec. 18, 2009 (KR) 10-2009-0126733

(51) Int. Cl. G06Q 50/12; G06Q 30/02; G06Q 40/00; G06Q 30/06

(52) U.S. Cl. 705/14.23; 705/26.1; 705/39

(57) ABSTRACT

A hotel room marketing and operating system includes a room-selling server for providing the room vendee with room-selling information related to the plurality of rooms of the hotel or the residence; an operation server for receiving the room-selling information on the rooms from the room-selling server, calculating a sales amount of a room of each room vendee based on operation information for marketing and operating the hotel rooms and providing a result of calculating the sales amount of each room; requesting and receiving sales and operation information and a result of calculating a sales amount of a room purchased by the vendee.

### TECHNICAL FIELD

The present invention relates to a system and method for marketing and operating hotel rooms by a plurality of room owners, and particularly, to a system and method for marketing and operating hotel rooms, in which the rooms of a hotel or a residence are sold or rented to individuals or a corporation through an operation program of a room-selling server or an operation server, and the rooms are sold and operated based on information on guests possessed by small investors (vendees).

### BACKGROUND ART

Generally, a hotel is a business in a service sector in which business owners or operating companies, make profits by selling rooms and renting or directly operating subsidiary facilities within the whole space of the hotel. Although rooms of a residence and rights to use the rooms are sold to a plurality of users, the residence is operated by an operating company like hotel management. Since the residence is operated to share profits among the investors as a dividend after all the expenses and taxes are deducted from the total sales amount or the users use the rooms for a set days like a condominium, actual investors or users having a membership do not know how much the investment profit rate is with respect to the sales amount, of the rooms. Furthermore, while a guaranteed profit rate is limited, if there is a deficit, the investors take over whole the deficit, and thus the residence is the worst system as an investment product. Considering limited conditions of a land (a place in an urban area) where the hotel should be placed or top class interiors and furniture reflecting tendency of guests, an astronomical amount of investment is required. However, the hotel can be an unprofitable business considering actual room rates or occupancy rates of the rooms. However, from the standpoint of a nation, hotel industry is a very important sector that should not be simply determined only for profit generation, since the hotel business is a tourist business, i.e. an industry without chimney, and the most important foundation of the tourist business is the hotel. The hotel business is an environmental business which advertises Korean brands all over the world and a starting point of an important business connected to awareness of the country in the future. However, the hotel business has been in a structure incapable of being revitalized or making a great profit although the government fully provides political supports.

FIGS. 1 and 2 are system configurations showing a method of operating rooms of a hotel or a residence.

The conventional method of marketing and operating rooms of a hotel and a residence (hereinafter, referred to as a hotel) is divided into two types, which are shown in the figure as a first operation system 110 and a second operation system 120.

In the first operation system 110, investors or corporations invested in a hotel (hereinafter, referred to as an investor) construct all the facilities and equipment needed to operate the hotel. If the hotel is constructed in this way, a business agent 115 such as the investor establishes and operates a directly managed operating company 111 of its own. Alternatively, in the second operation system 120, a separate operating company 112 is established to market and operate the rooms on behalf of room vendees 116 who own the rooms. The directly managed operating company 111 or the separate operating company 112 makes extra incomes by directly operating or renting subsidiary facilities such as a shopping center, a restaurant, a coffee shop, a wedding hall, and the other banquet halls, in addition to the profits generated by operating the hotel rooms.

Particularly, in the second operation system 120, the investors construct all the facilities and equipment needed for the hotel, collect the invested amount by selling 113 all the rooms to vendees 116, and establish the operating company 112 to sell and operate all the rooms on behalf of the vendees. All the generated sales amounts (including sales amounts of the rooms) belong to the operating company 112, and the subsidiary facilities are operated in the same manner as the first operation system 110. The operating company 112 directly operates or rents the subsidiary facilities, such as a shopping center, a restaurant, a coffee shop, a wedding hall, and the other banquet halls, adds the sales amounts of the rooms and the subsidiary facilities, and splits the profits among the vendees 116 after deducting expenses and taxes.

However, in the conventional method of operating a hotel, the investors bear all the cost of the land and construction with their own funds, or the investors establish a corporation and pay for the land, and construction with the investments of the shareholders. However, although the government supports to a large extent, the profit rate with respect to the investments is low. In addition, although the investors sell 113 the hotel rooms to room vendees 116 and recover the invested amount in an early stage in the same manner as is done for the residence, endless disputes and lawsuits arise between the room vendees 116 and the operating company 112 due to transparency and credibility of the operation, in the process of entrusting and operating the rooms through the operating company 112.

In addition, although the conventional hotel and residence operating company recruits management experts possessing both experience and marketing capability and operates the hotel or the residence, costs accompanied by the sales are enormous considering room occupancy rates related to sales of rooms that should be made persistently day by day. Since the conventional method adopts a structure that cannot introduce other incentive systems in relation to the Sales of rooms (a method of sharing profits after sales are generated by the operating company), there are a lot of inefficient factors such as even a room vendee 116 of the residence uses other hotels which provide better conditions when the room vendee 116 needs to use a hotel.

### DISCLOSURE OF INVENTION

### Technical Problem

Therefore, the present invention has been made in view of the above problems, and it is an object of the present invention to provide a system and method for marketing and operating hotel rooms, in which investors construct a hotel or a residence, sell the rooms to vendees and entrust, operation of subsidiary facilities, overall management of the hotel buildings, a part of sales, management and operation of the hotel rooms to a specialized operating company, thereby collecting the enormous initial investment in an early stage, recovering credibility of room vendees possessing the rooms using a standardized management and operation system, and changing a way of thinking to an investment industry that can expect a high profit rate.

Another object of the present invention is to provide a system and method for marketing and operating hotel rooms, in which the hotel rooms are sold to room vendees by the type of a room, and the vendees themselves perform sales activities based on a result of selling the rooms and generate sales for each room through online, phone calls, facsimiles, or the like. In addition, the sales amount of the rooms generated by a specialized operating company is deposited into business accounts of the room vendees, and the structure of operation expenses that is not clear until now is standardized. Then, fixed costs and variable costs are paid to the specialized operating company as a management fee, and thus a new system for marketing hotel rooms can be operated.

Still another object of the present invention is to provide a safe and profitable real-estate investment product by minimizing the risk of hotel management through the specialized operating company, in addition to providing a new investment in which individuals or some corporations may invest in the assets of a hotel with a small amount so as to safely increase a profit rate, and room vendees may expect a high profit depending on the result of sales made by the room vendees themselves and secure a minimum profit with respect to the investment guaranteed by the investor.

### Technical Solution

To accomplish the above object, according to one aspect of the present invention, there is provided a hotel room marketing and operating system in which a hotel has a plurality of rooms, the system comprising: an operation server for receiving room-selling information related to the plurality of rooms of the hotel or a residence, making a deposit of an amount paid by a guest who has used a room into a bank account of a corresponding room vendee based on sales and operation information of the hotel room, receiving a management fee from each vendee, calculating a sales, amount of the room of the room vendee, and providing a result of calculating the sales amount of the room; and a plurality of vendee terminals installed with an operation program connected to the operation server, for purchasing a desired room, and requesting and receiving sales and operation information and a result of calculating the sales amount of the room purchased by the vendee.

The hotel room marketing and operating system further comprises a room-selling server for providing the room vendee with the room-selling information related to the plurality of rooms of the hotel or the residence.

The operation server includes: a data transmission and reception unit for transmitting and receiving data in association with the operation program; an operation information input unit for receiving operation information of each room; a control unit for controlling each component to calculate a sales amount of each room based on the inputted operation information and room-selling information; a per-room sales amount calculation unit for calculating the sales amount of each room; a room-selling information DB for storing the room-selling information of each room; an operation information DB for storing detailed information on operation of the room; a service provider DB for storing information on a service provider of the room vendee who has registered the purchased room; and a member information DB for storing information on guest members of each service provider of the room.

The per-room sales amount calculation unit calculates a sales amount of: each room so as to assign sales of a room generated at a specific unit to the room vendees in order.

The per-room sales amount calculation unit applies a different rental fee to each room and calculates a sales amount of each room so as to distribute an amount deducting the differently applied rental fee from the sales amount of a room to a renter designated to a corresponding room depending on an occupancy rate and data on use of the room based on a marketing result of each room.

The per-room sales amount calculation unit calculates a sales amount of each room so as, to evenly split a total sales amount among renters by dividing the total sales amount generated at a specific unit by the number of rooms.

The service provider on the side of the plurality of vendee terminals who has purchased the room from the room-selling server of the investor or an offline room-selling agent registers as an individual service provider or a corporation service provider to launch sales of the room, becomes an agent of the operation server and manages to directly deposit a sales income generated from his or her own hotel room into a bank account of the service provider, pays a fixed fee and a variable fee of the hotel managed by the operating company as a contracted management fee on the basis of a contract unit such as a daily, weekly or monthly basis from the sales amount of the room of the registered service provider.

The purchase of the rooms is an ownership registration purchase, and the service provider is a room vendee.

The service provider on the side of the plurality of vendee terminals who has purchased the room from the room-selling server of the investor or an offline room-selling agent registers as an individual service provider or a corporation service provider to launch sales of the room and protects the right on the deposit, becomes an agent of the operation server and manages to directly deposit a sales income generated from the rented hotel room into a bank account of the service provider, and pays a fixed fee and a variable fee of the hotel managed by the operating company as a rental fee and a contracted management fee on the basis of a contract unit such as a daily, weekly or monthly basis from a sales amount of: the room of the renter registered as a service provider.

The purchase of the rooms is a rental purchase in which a rental period is set for the rented room, and the room vendee is the renter.

A method of operating the plurality of rooms of the hotel or the residence includes a method in which the service provider who has purchased the room through the operation server performs sales activities by himself or herself and sells the room that the vendee has purchased (hereinafter, referred to as a I check-in method), a method in which a regular price guest paying a regular room rate determined by the hotel or a discount price guest paying a discounted room rate is assigned by turns to an unoccupied hotel room that is, not sold in the I check-in method (hereinafter, the method of checking in the regular price guest is referred to as a II-1 check-in method, and the method of checking in the discount price guest is referred to as a II-2 check-in method), and a method in which if a room vendee attracts guests in a day more than the rooms that the vendee has purchased, the guests are assigned with rooms of the other room vendees, and room charges are split based on a certain sales amount allocation rule (e.g., a rule of allocating the room charges to room vendees who have attracted the guests and room vendees who have allowed to use their rooms) (hereinafter, referred to as a III check-in method).

In the methods described above, when, the II-1 check-in method or the II-2 check-in method should be, used so that all the room vendees may receive same benefits, and if all the rooms are occupied in the I check-in, method or the III check-in method, a guest is immediately assigned with a room in the II-1 check-in method or the II-2 check-in method when the room is unoccupied.

The II-1 check-in method or the II-2 check-in method may be divided into several check-in methods depending on a discount rate of a discounted price so that all the room vendees may receive same benefits, in which the II-2 check-in method can be subdivided into a II-2-1 check-in method if the discount rate is 10%, a II-2-2 check-in method if the discount rate is 20%, a II-2-3 check-in method if the discount rate is 30%, and the like.

In the methods described above, when an unoccupied room is assigned to a guest in the II-1 check-in method of the regular price guest and the II-2 check-in method of the discount price guest, all the rooms are assigned by turns depending on the number of guests, and a starting room is assigned with a guest with a different cycle.

The II-2-1 check-in method, the II-2-2 check-in method and the II-2-3 check-in method also determine a starting room and assign a room to a guest as described above.

According to another aspect of the present invention, there is provided a method of selling a plurality of rooms and marketing and operating the rooms of a hotel, the method comprising the steps of: (a) determining whether or not room-selling information of the rooms of the hotel or a residence is inputted and storing the inputted room-selling information in a room-selling information DB; (b) determining whether or not operation information of the rooms is inputted, from, an operation program and storing the inputted operation information; (c) depositing an amount paid by a guest who has used a room into a bank account of a corresponding room vendee based on the room-selling information and the operation information, receiving a management fee from each service provider, and calculating a sales amount of each room; and (d) transmitting information on the calculated sales amount of each room to a corresponding room vendee or the service provider.

If purchase of a room is made offline, step (a) inputs detailed room-selling information of the room, such as a purchase amount, a management fee and a rental fee (in a case of a rent), into the operation server of an operating company.

Step (c) calculates a sales amount of each room so as to assign sales of a room generated at a specific unit to room vendees in order.

Step (c) applies a different rental fee to each room and calculates a sales amount of each room so as to assign sales of a room to a designated renter depending on an occupancy rate and data on use of the room based on a marketing result of each room.

Step (c) calculates a sales amount of each room so as to evenly split a total sales amount among renters by dividing the total sales amount generated at a specific unit by the number of rooms.

In step (c), a method of operating the plurality of rooms of the hotel or the residence includes a method in, which the service provider who has purchased the room through the operation server performs sales activities by himself or herself and sells the room that the vendee has purchased (hereinafter, referred to as a I check-in method), a method in which a regular price guest paying a regular room rate determined by the hotel or a discount price guest paying a discounted room rate is assigned by turns to an unoccupied hotel room that is not sold in the I check-in method (hereinafter, the method of checking in the regular price guest is referred to as a II-1 check-in method, and the method of checking in the discount price guest is referred to as a II-2 check-in method), and a method in which if a room vendee attracts guests in a day more than the rooms that the vendee has purchased, the guests are assigned with rooms of the other room vendees, and room charges are split based on a certain sales amount allocation rule (e.g., a rule of allocating the room charges to room vendees who have attracted the guests and room vendees who have allowed to use their rooms) (hereinafter, referred to as a III check-in method).

In the methods described above, when the II-1 check-in method or the II-2 check-in method should, be used so that all the room vendees may receive same benefits, and if all the rooms are occupied in the I check-in method or the III check-in method, a guest is immediately assigned with a room in the II-1 check-in method or the II-2 check-in method when the room is unoccupied.

The II-1 check-in method or the II-2 check-in method may be divided into several check-in methods depending on a discount rate of a discounted price so that all the room vendees may receive same benefits, in which the II-2 check-in method can be subdivided into a II-2-1 check-in method if the discount rate is 10%, a II-2-2 check-in method if the discount rate is 20%, a II-2-3 check-in method if the discount rate is 30%, and the like.

In the methods described above, when an unoccupied room is assigned to a guest in the II-1 check-in method of the regular price guest and the II-2 check-in method of the discount price guest, all the rooms are assigned by turns depending on the number of guests, and a starting room is assigned with a guest with a different cycle.

The II-2-1 check-in method, the II-2-2 check-in method and the II-2-3 check-in method also determine a starting room and assign a room to a guest as described above.

According to another aspect of the present invention, there is provided a computer readable recording medium capable of recording, in a computer, a program for implementing a method of selling a plurality of rooms and marketing and operating the rooms of a hotel, the method comprising: (a) a function of determining whether or not room-selling information of the rooms of the hotel or a residence is inputted and storing the inputted room-selling information in a room-selling information DB; (b) a function of determining whether or not operation information of the rooms is inputted from an operation program and storing the inputted operation information; (c) a function of depositing an amount paid by a guest who has used a room into a bank account of a corresponding room vendee based on the room-selling information and the operation information, receiving a management fee from each service provider, and calculating a sales amount of each room; and (d) a function of transmitting information on the calculated sales amount of each room to a corresponding room vendee or the service provider.

### Advantageous Effects

As described above, the system and method for marketing and operating hotel rooms according to the present invention sells hotel rooms by the unit of room, and thus a small investor (a vendee) becomes a service provider. Therefore, the room vendee himself or herself performs a role of a sales person, and thus sales of the rooms are increased. If the rooms are operated by a tourist company or a person related to a tourist business, the occupancy of the rooms will be further increased. If the hotel rooms are rented, the renter of each room may contribute to create a lot of small businesses who can participate in hotel operation that is at the center of the tourist business with a small amount of money.

In addition, from the viewpoint of investors, a hotel which requires a vast amount of investment can be sold by the unit of room, and thus the invested amount can be collected in an early stage. Therefore, companies may actively invest in hotels, and furthermore, even individuals may have a chance to participate in investing in the tourist business that the government should support, and thus all the national industries will prosper so as to develop the most desirable environmental industry without chimney and facilitate flow-in of foreign currencies.

In addition, the system, and method for marketing and operating hotel rooms according to the present invention is operated by an operating company and efficiently calculates sales of each room using a room-selling server, a room-selling information DB, an operation information DB, a service provider DB, and a guest membership information DB. Therefore, the service provider of each room may check a sales state of a room in real-time if operation information is inputted, and a plurality of service providers becomes agents of hotel operation, and thus the effect of collecting guests by a plurality of operators will be a differentiated feature compared with the conventional hotel business.

### BRIEF DESCRIPTION OF THE DRAWINGS

FIGS. 1 and 2 are views schematically showing an operation system illustrating a conventional method of operating hotel rooms.

FIG. 3 is a view schematically showing a hotel room marketing and operating system according to an embodiment of the present invention.

FIG. 4 is a view showing an operation method in a hotel room marketing and operating system according to an embodiment of the present invention.

FIG. 5 is a detailed block diagram showing an operation server of the purchased rooms of FIG. 3.

FIG. 6 is a view showing a method of calculating a sales amount of a room of a hotel or a residence and a method of distributing the sales amount according to the present invention.

FIG. 7 is a view showing a daily room occupation state for illustrating a method of operating a room of a hotel or a residence.

FIG. 8 is a flowchart illustrating a method of marketing and operating hotel rooms according to an embodiment of the present invention.

### DESCRIPTION OF SYMBOLS

10-1 . . . 10-n: First to n-th vendee terminals
20: Room operation server
30: Room room-selling server
40: Operation program
21: Operation information input unit
22: Data transmission and reception unit
23: Control unit
24: Per-room sales amount calculation unit
25: Room-selling information DB
26: Operation information DB
27: Service provider DB
28: Member information DB

### BEST MODE FOR CARRYING OUT THE INVENTION

The preferred embodiments of the present invention will be hereafter described in detail, with reference to the accompanying drawings.

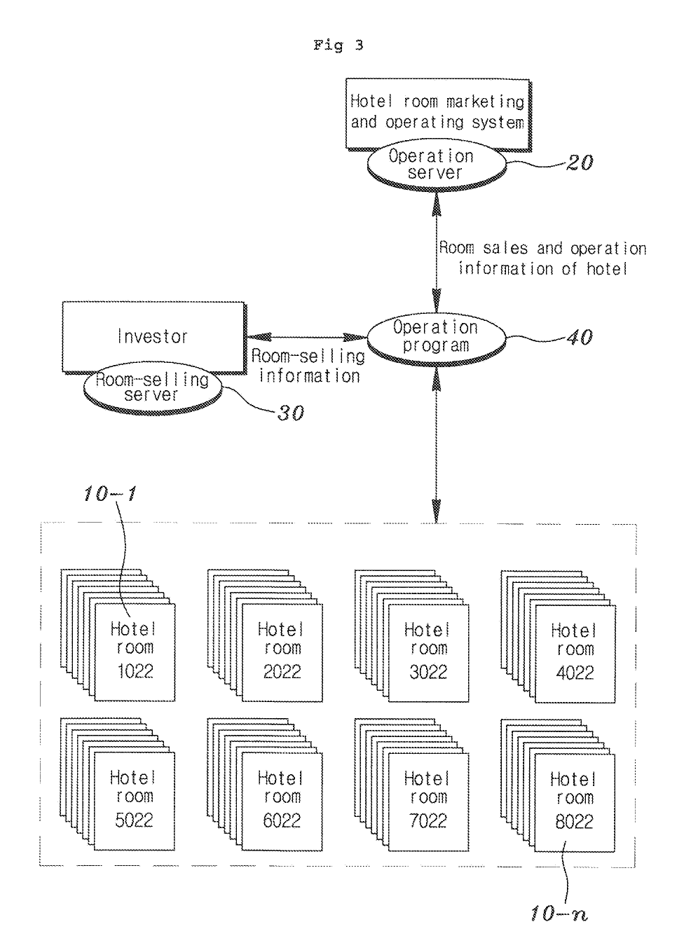

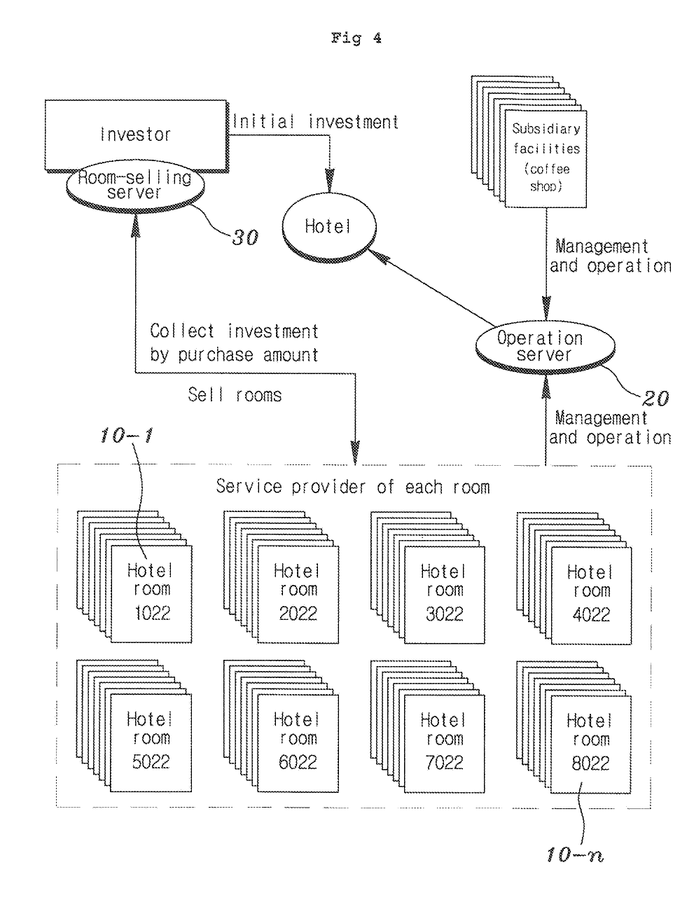

FIG. 3 is a view schematically showing a hotel room marketing and operating system according to an embodiment of the present invention, and FIG. 4 is a view showing an operation method in a hotel room marketing and operating system according to an embodiment of the present invention;

Referring to FIG. 3, the hotel room marketing and operating system includes a room-selling server 30 of an investor for providing room-selling information of a plurality of rooms by first to n-th vendee terminals 10-1 to 10-n, which are connected to n small investors (vendees) who have purchased one or more rooms of a hotel or a residence, and the investor, an operation server 20 for receiving the room-selling information related to the rooms of the hotel or the residence from the room-selling server 30 of the investor, making a deposit of an amount paid by a guest who has used a room into the bank account of a corresponding room vendee based on sales and operation information of the hotel room, receiving a management fee from each vendee, calculating a sales amount of a room of each room vendee, and providing a result of calculating the sales amount of each, room, and a plurality of vendee terminals installed with an Internet-based operation program 40 connected to the room-selling server 30 and the operation server 20 and purchasing a desired room, and transmitting and receiving data for requesting and receiving sales and operation information and a result of calculating a sales amount of a room purchased by the vendee.

Although it is described that the room-selling server of the investor is connected to the operation program 40 online through an Internet communication network, it is possible to sell the hotel rooms by the unit of room and register the room-selling information offline in practice.

Here, the online room-selling server 30 of the investor or the offline investor becomes an agent who sells hotel rooms to room: vendees and directly operates or rents subsidiary facilities. The room-selling server 30 of the investor allows the investor to directly operate some of the hotel rooms when selling the hotel rooms. In this case, remaining rooms other than the directly operated rooms are sold to individuals. The service provider on the side of the first to n-th vendee terminals 10-2 to 10-n who has purchased the room from the room-selling server 30 of the investor or the offline room-selling agent registers as an individual service provider or a corporation service provider to launch sales of the room and protects the ownership or the right on the deposit by making an ownership registration or a rental registration.

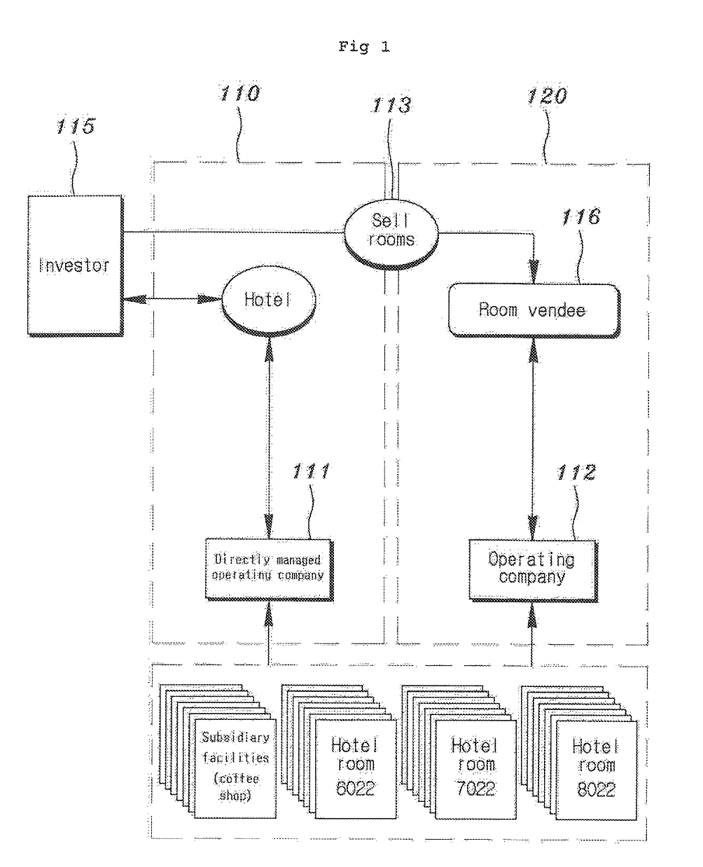

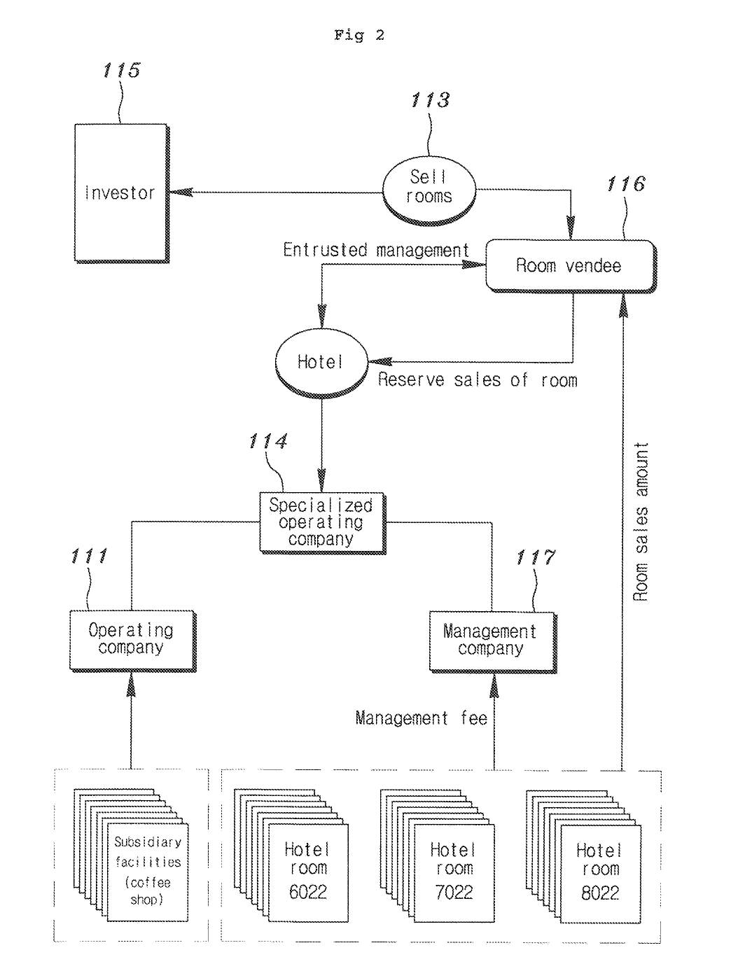

The vendee of each room 11-1 to 11-n registered as a service provider pays a fixed fee and a variable fee of the hotel managed by an operating company from the sales amount generated from his or her own room as a management fee on the basis of a contract unit such as a daily, weekly or monthly basis. That is, the operating company (refer to FIG. 1) becomes an agent of the operation server of the hotel room marketing and operating system, manages to directly deposit a sales income generated from the hotel room into the room vendee, i.e., an individual service provider, receives room-selling information of a corresponding room from the room-selling server 30, and transfers information on each room to the room vendee in real-time. In addition, a service provider who rents a room from a room vendee also directly receives a sales amount of the rented room from the operation server 20 through a program, and pays a corresponding management fee to the room vendee, i.e., the owner of the room, together with a rental fee or pays a predetermined management fee to the operating company. The investor (refer to FIG. 1), i.e., the owner of unsold rooms, also entrusts sales and operation of the rooms to the operating company 114, i.e., the agent of the operation server 20, but manages sales of a corresponding room by himself or herself, and pays a predetermined management fee to the operating company.

The room vendee who owns the hotel room may make a rental contract prescribed by the commercial law, and a service provider who rents the room may make the contract by specifying a rental period. At this point, the service provider who rents the room opens a business so as to generate sales in the same manner as the room vendee.

In addition, the operating company of the hotel is a separated operating company which determines and receives a management service fee of a predetermined amount per room (a fixed fee, a variable fee and a management fee) and is fully in charge of the operation, management, marketing, safety and the like of the hotel. In addition, the operating company may deduct salaries of employees and management cost of the operating company from the management fee received for each room, accumulate surplus amounts, and pay for renovation and maintenance of the hotel. Although the operating company is a company separately established for the hotel room marketing and operating system in relation to the operation of the hotel without connection to the investors and the room vendees, the investors may operate the hotel by themselves. In addition, since the operating company recruits management specialists for the sale and management of the hotel rooms, the operation system capable of maximizing the investment profit rate of each room vendee can be differentiated from conventional hotel operating companies. The system of the operating company side is managed as the operation server 20 of the hotel room marketing and operating system; and a method of operating the hotel using such a system will be described below in detail.

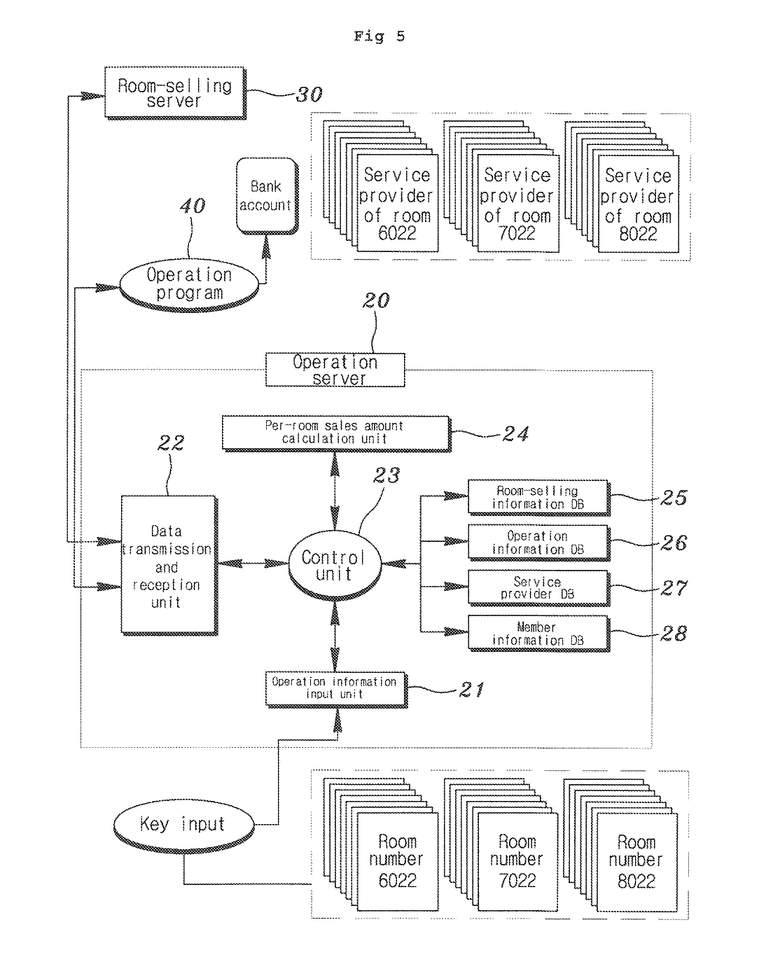

Referring to FIGS. 3 and 4, room-selling announcement of hotel rooms is posted online on the room-selling server 30 of the investor. Then, the first vendee terminal 10-1 is connected to the room-selling server 30 of the investor, applies for a room desired by the vendee among the rooms announced to be sold, and completes purchase of the room through a room-selling contract process. The rooms are sold to the other vendee terminals in the same manner, and at this point, the room-selling server 30 of the investor transmits room-selling information of the rooms of the first to n-th vendee terminals 10-1 to 10-n to the operation server 20 of the operating company through the Internet operation program 40. The Internet operation program 40 can be configured as an Internet network or as an internal communication network (Intranet) between the operation server 20 of the operating company and the room-selling server 30 of the investor. If purchase of a room is made offline, it is also possible to input detailed room-selling information such as a purchase amount, a management fee, and a rental fee (in the case of rental) of the room into the operation server 20 of the operating company and drive the operation server 20. The operation server 20 of the operating company receives and stores the rental or purchase information and transmits a sales and operation state of each room to a requesting room vendee terminal. That is, the room vendee terminal requests a variety of information including sales information or a current state of a room that the room vendee terminal has rented or purchased, and the operation server 20 has a function of transmitting desired information to the requesting room vendee terminal in response to the request. In addition, the operation server 20 of the operating company makes it possible to increase sales of hotel rooms and operate the hotel rooms in a variety of ways using the sales and operation information of each room based on the room-selling information of each room. This will be described in detail with reference to the detailed block diagram of the operation server 20 shown in FIG. 5.

FIG. 5 is a detailed block diagram showing a method of marketing and operating hotel rooms of the operation server 20 having information on the room vendee of each room.

The operation server 20 of FIG. 5 includes a data transmission and reception unit 22 for transmitting and receiving data in association with the operation program 40, an operation information input unit 21 for receiving operation information of each room, a control unit 23 for controlling each component based on the inputted operation information and rental and room-selling information, a per-room sales amount calculation unit 24 for calculating a sales amount of each room, a room-selling information DB 25 for storing purchase information of the room of each vendee, an operation information DB 26 for storing detailed information on operation of the room, a service provider DB 27 for storing information on room renters and vendees, and a member information DB 28 for storing information on guest members provided by the service provider of each room.

The control unit 23 for operating the hotel transmits information on the room-selling information DB 25 and the operation information. DB 26 to the per-room sales amount calculation unit 24 in order to calculate a sales amount and deduct related expenses. The per-room sales amount calculation unit 24 calculates a sales amount of each room using the information received from the control unit 23. Then, the control unit 23 stores a result of the calculation in the service provider DB 27. Then, the control unit 23 transmits operation information or sales information of each room whenever the service provider requests. The operation information input unit 21 receives information on the operation state of each room at all times.

The data transmission and reception, unit 22 is an interface connected to the operation program to receive a data request from the vendee terminals 10-1 to 10-n and transmit desired data. In addition, the control unit 23 receives sales and operation information of hotel rooms in real-time from the operation information input unit 21 and stores the current rooms occupation state in the operation information DB 26 in real-time. In addition, the per-room sales amount calculation unit 24 calculates a sales amount of each room under the control of the control unit 23. The control unit 23 stores information on the sales amount calculated by the per-room sales amount calculation unit 24 in the service provider DB 27 by the unit of service provider and provides the operation program with the information on the sales amount in response to a request of the service provider. Such a method of calculating a sales amount of a room by the per-room sales amount calculation unit 24 can be provided in a variety of ways depending on the room-selling information and the operation information.

For example, this is a calculation method for determining an order of each service provider and assigning sales of a guest generated at a specific unit to a service provider of each room in order. This is a method of determining a calculation reference date and programming to make sales of each room to be even considering that deviation of room assignment can be large since there are a lot of rooms. That is, the operation program is a program which makes a difference of average sales in a period within one time room assignment if rooms are assigned for an extended period of time under the law of large numbers regardless of sales generated by the guests stored in the member information DB 28. In an embodiment, if the calculation reference date is May 31, and a service provider assigned with the last sales of May 31 is the service provider of room number 180, the sale generated by the first member on June 1 is assigned to the service provider of room number 181, and at this point, the sales stored in the member information DB 28 for each room are generated as sales of each room regardless of the assignment.

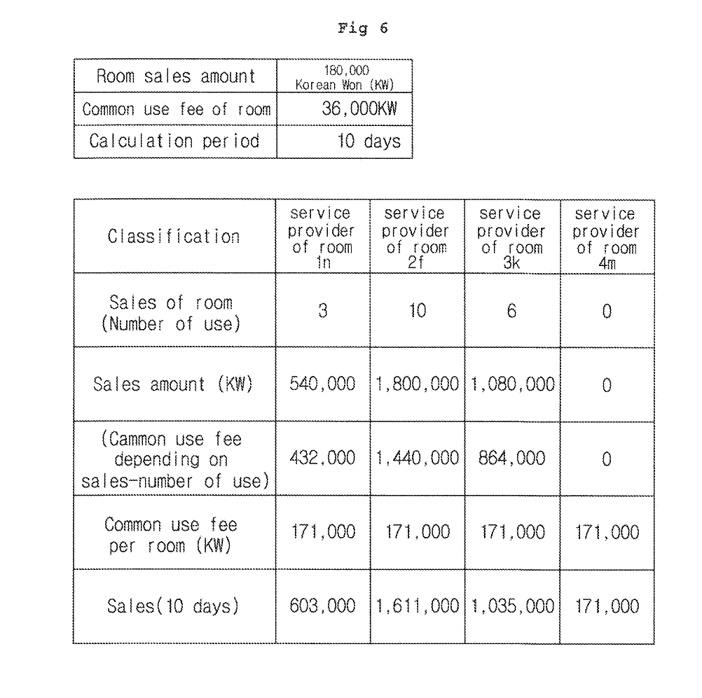

In addition, another method of calculating a sales amount of each room is a method of allocating the sales amount of each room to a service provider (renter) assigned to a corresponding room, and at this point, the sales amount is applied differently for each room. That is, a room occupancy rate is estimated for each room, and a certain amount of the sales of a room is newly determined as a fee for using common areas. A large amount is collected from a room of high sales as a fee for using the common areas, whereas a small amount proportional to low sales is collected from a room of low sales as a fee for using the common areas, and thus the fee for using the common areas is evenly distributed in proportional to circular sales of the rooms. Then, the gape of the circular sales is reduced between a room having a large number of guests and a room having a small number of guests, and thus it can be a method of guaranteeing a minimum profit. This is described using an example shown in FIG. 6.

FIG. 6 is a view showing a method of calculating a sales amount of a room of a hotel or a residence and a method of distributing the sales amount according to the present invention.

Referring to FIG. 6, a sales amount of a room for ten days is calculated by multiplying the number of days using the room by a room rate per night and then subtracting a common use fee of each room from the result of the multiplication. Then, in the case of room number 1, the number of using the room, i.e., 3 days, is multiplied by the room rate per night of 180,000 Korea Won (KW) and then a common use fee of 108,000 KW (36,000 KW×3 times) is subtracted from the result of the multiplication, and thus a sales amount of 432,000 KW is generated. As shown in FIG. 6, since room number 2 is used for ten days, the largest sales amount of 1,440,000 KW is generated, and its common use fee is 360,000 KW. In the case of room number 4, the room is not used, and thus its sales amount is 0. The common use fee for using other facilities such as a parking lot, the lobby and like is 684,000 KW, and the total common use fee is divided by the number of rooms, i.e., 4, and thus a common use fee per room is calculated as 171,000 KW. If an amount proportional to a ratio of the total use fee to the total number of using a room, which is calculated by adding occupation rates of all the rooms, and the calculated fee is allocated to the corresponding room, a profit gap between a room of a large amount of sales and a room of a small amount of sales is reduced. At this point, the common use fee of each room is used as a management fee to be paid to the operating company, and even a room that does not generate sales at all may be guaranteed a minimum profit due to the sales generated by assigning a room by turns.

In addition, in another method of calculating a sales amount, it is possible to evenly and equally distribute a monthly sales amount among service providers as much as the number of rooms. For example, a total sales amount of four rooms is divided by four, i.e., the total number of rooms. If the sales amount of the four rooms is 3,420,000 KW for 10 days, and this is divided by four, i.e., the number of rooms, the sales amount generated per room is 855,000 KW. Accordingly, the sales amount generated as the sales of the operating company is shared among the service providers in the form of a resale.

In addition, in another method of calculating a sales amount, each of the service providers sells his or her rooms by himself or herself, and the sales amount of the rooms is the total sales amount of each service provider. The operating company sells unsold rooms and uses the share of each service provider as a predetermined management fee and expenses. In such an operation method, although the sales gap among the rooms of the same conditions appears to be large, a sales amount of a room can be increased depending on sales efforts.

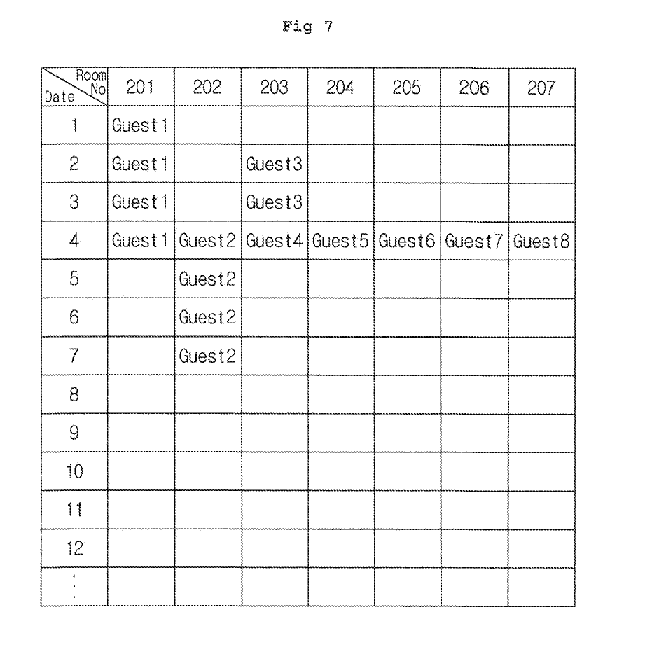

FIG. 7 is a view showing a daily room occupation state for illustrating a method of operating a room of a hotel or a residence.

A method of operating a plurality of rooms of a hotel or a residence includes a method in which a room vendee, i.e., a service provider who has purchased a room through the operation server 20, performs sales activities by himself or herself to have a guest check in the room that the vendee has purchased (hereinafter, referred to as a I check-in method), a method in which a regular price guest paying a regular room rate determined by the hotel or a discount price guest paying a discounted room rate is assigned by turns to an unoccupied hotel room that is not sold in the I check-in method (hereinafter, the method of checking in the regular price guest is referred to as a II-1 check-in method, and the method of checking in the discount price guest is referred to as a II-2 check-in method), and a method in which if a room vendee attracts guests in a day more than the rooms that the vendee has purchased, the guests check in the rooms of the other room vendees, and room charges are split based on a certain sales amount allocation rule (e.g., a rule of allocating the room charges to room vendees who have attracted the guests and room vendees who have allowed to use their rooms) (hereinafter, referred to as a III check-in method).

In addition, in the methods described above, when the II-1 check-in method or the II-2 check-in method should be used so that all the room vendees may receive the same benefits, and if all the rooms are occupied in the I check-in method or the III check-in method, a guest is immediately assigned with a room in the II-1 check-in method or the II-2 check-in method when the room is unoccupied.

In addition, the II-1 check-in method or the II-2 check-in method may be divided into several check-in methods depending on the discount rate of a discounted price so that all the room vendees may receive the same benefits. That is, the II-2 check-in method can be subdivided into a II-2-1 check-in method if the discount rate is 10%, a II-2-2 check-in method if the discount rate is 20%, a II-2-3 check-in method if the discount rate is 30%, and the like.

In addition, in the methods described above, an amount paid by a guest who has used a room is deposited into the bank account of a corresponding room vendee. That is, the amount paid by the guest is deposited into the bank account of the room vendee, and the room vendee pays a portion of the amount to the operating company as a management fee.

In addition, in the methods described above, when an unoccupied room is assigned to a guest in the II-1 check-in method and the II-2 check-in method, all the rooms are assigned by turns with a cycle having a different starting point.

For example, it is assumed that the entire rooms include room number 100 to room number 200. If a starting room is determined (a room for starting a method is determined by drawing or in a variety of methods), guests are assigned to a room from the starting room. For example, if it is assumes that the II-1 check-in method starts from room number 132 and the II-2 check-in method starts from room number 156, the II-1 check-in method starts assignment from room number 132, and the II-2 check-in method starts to assign a room to a guest from room number 156.

At this point, it is natural that the II-2-1 check-in method, the II-2-2 check-in method and the II-2-3 check-in method also determine a starting room and assign a room to a guest as described above.

In an embodiment, if a guest checked in a specific room (room number 203) of a hotel or a residence on a certain day and checked out the next day and thus the room is in an unoccupied state, and there are five guests belonging to a group that the room vendee has attracted, the guests are assigned to the specific room (room number 203) first and then assigned to the other rooms (room numbers 204 to 207) in order.

While guest 1 (dates 1 to 4) uses room number 201 and guest 3 (dates 2 and 3) uses room number 203, if a room vendee, i.e., the service provider of room number 202, makes sales of rooms and attracts an individual guest; 2 (dates 4 to 6) and guests 4 to 8 of a seminar group (use rooms only on date 4), guests 4 to 8 are assigned to use unoccupied rooms of the other room vendees (room numbers 203 to 207), and room charges are split based on a certain predetermined sales amount allocation rule (7:3).

When the guests pay for the room charges in cash or on a card, a residential registration number, a business number and a cellular phone number are inputted, and the room charges are deposited into the bank accounts of the room, vendees of corresponding rooms through the operation server 20.

Next, each room vendee pays a management fee to the operating company for managing hotel rooms every month, and the operation server manages details of the room sales amount and the management fee of each room vendee.

It is apparent that the sales amount can be calculated in a variety of ways in addition to the sales amount calculation methods described above, and any kind of room sales amount can be calculated according to an agreement made between room vendees and the operating company which actually operates the hotel.

The control unit 23 transmits a result of calculating a sales amount of each room to the vendee terminal in a variety of ways in response to a request from the room vendee.

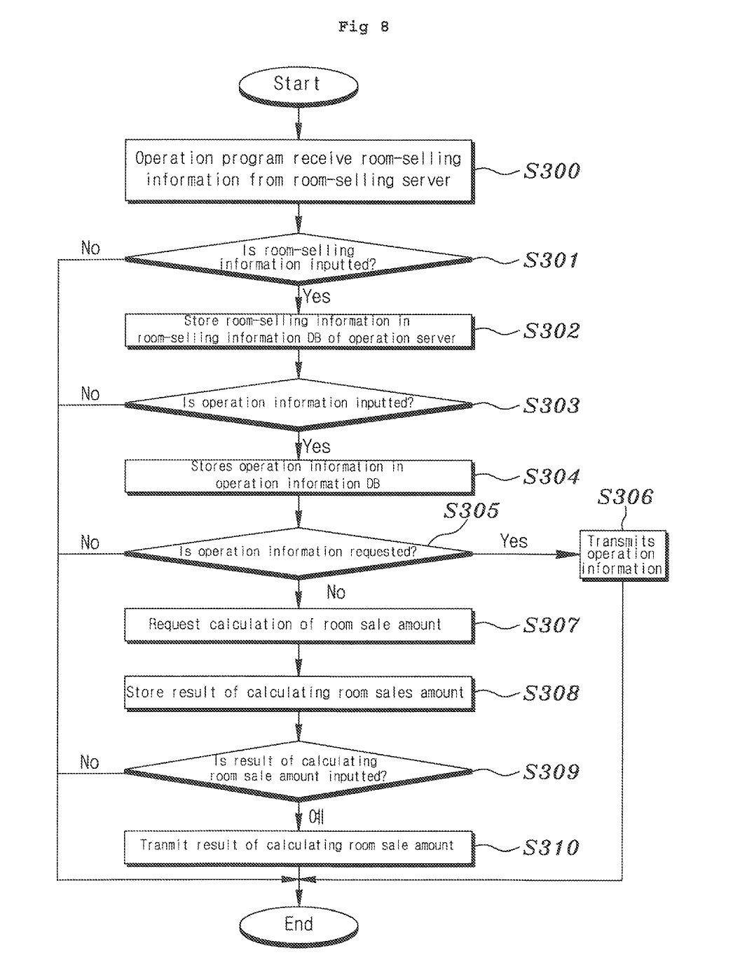

FIG. 8 is a flowchart illustrating a method of marketing and operating hotel rooms according to an embodiment of the present invention.

The hotel room management and operation server 20 receives room-selling information from the room-selling server 30 of an investor or inputs room-selling information after selling hotel rooms S300.

The control unit 23 determines whether room-selling information is inputted from the operation program or the room-selling server 30 of the investor S301. Here, the room-selling information informs room numbers sold to room vendees. In addition, if the room-selling information is inputted, the control unit 23 stores the room-selling information in the room-selling information DB 25 S302. Then, if sales and operation of the hotel rooms begins, the control unit 23 determines whether or not operation information according thereto, i.e., a state of occupation of a corresponding room or the like, is inputted S303 and stores the inputted operation information in the operation information DB S304. At this point, the control unit 23 determines whether or not an operation information request signal inquiring its own operation information is inputted from any one of the first to n-the vendee terminals 10-1 to 10-n S305. If the operation information request signal is inputted as a result of the determination, the control unit 23 transmits the operation information to a program of a corresponding service provider S306. If the operation information request signal is not inputted, the control unit 23 outputs the operation information to the per-room sales amount calculation unit 24 and requests calculation of a sales amount S307. The control unit 23 of the operation server deposits an amount paid by a guest who has used a room into the bank account of a corresponding room vendee, based on room sales and operation information of the hotel, receives a management fee from each room vendee, receives a sales amount of a room of each room vendee calculated by the per-room sales amount calculation unit 24, and stores the result of calculating the sales amount of a room in the service provider DB S308. Then, the control unit 23 determines whether or not a signal requesting the result of calculating its own sale amount of a room is inputted from any one of the first to n-the vendee terminals 10-1 to 10-n S309 and transmits the result of calculating its sale amount of a room to a corresponding service provider if the signal requesting the result of calculating a sale amount of a room is inputted S310.

The operation of the system and method for marketing and operating hotels rooms according to the present invention described above is described below.

The room-selling server 30 of the operation system according to the present invention allows selling rooms other than the rooms directly operated by an initial investor to service providers by the unit of room. If there is no room directly operated by the investor, all the rooms are sold, and room vendees who have purchased the rooms from the room-selling server 30 register as an individual service provider and operate the hotel rooms. In addition, the room-selling server 30 directly operates or rents subsidiary facilities other than the hotel rooms. If all the hotel rooms are rented, the hotel rooms can be rented in a method of determining a deposit and a rental fee of a room considering a view, a floor, a size and the like or in a method of determining the deposit or the rental fee to be equal for all the rooms. Although the room-selling server 30 is constructed as a program together with the system for marketing and operating rooms, it is possible to sell the rooms offline and transmit room-selling information to the control unit.

In addition, the control unit 23 of the operation system receives room-selling information of each room from the room-selling information DB 25 constructed by the room-selling server 30, inputs operation information for calculating a sales amount of each room, and calculates a sales amount, an operation and management fee and a profit of each room based on the previously constructed operation information DB 26. The method of calculating a sales amount of a room can be modified in a variety of ways as described above, and the sales amount can be calculated considering different occupation rates among the room, or the sales amount can be calculated differently depending on the deposit or the rental fee. This calculation is performed by the per-room sales amount calculation unit 24. After the per-room sales amount calculation unit 24 calculates a sales amount of a room from the information stored in the member information DB 28, the operation information DB 26 and the service provider DB 27, the control unit 23 displays and allocates a profit of each room deducted by the operation and management fee and various expenses through the room vendee terminal or generate sales of a corresponding room, and receives an operation and management fee and various expenses. In addition, each of the room vendees or rented service providers may confirm the current state of a room at all times and confirm the state of sales amount and expenses in real-time according to the sale of the rooms.

The operating company is a specialized operation corporation which operates the hotel room marketing and operating system according to the present invention, determines and receives a management service fee, and is fully in charge of operation, management, marketing, safety and the like of a hotel, and the operating company is not an investor, a room vendee or a rented service provider, but a separate corporation.

In the embodiments described above, although it is described as a registered purchase of rooms, all the room can be rented. In this case, the service provider of each room is a renter, and each room is rented to the renter. An operating company manages the room and receives a management fee and expenses from the service provider of each room in the same manner as is done for a room vendee, and the only difference is that a rental fee is separately charged.

The methods of the present invention described above can be implemented as a program and stored in a recording medium (CD-ROM, RAM, ROM, memory card, hard disk, optical magnetic disk or the like) in a form that can be read using software.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

1. A hotel room marketing and operating system in which a hotel has a plurality of rooms, the system comprising:
an operation server for receiving room-selling information related to the plurality of rooms of the hotel or a residence, making a deposit of an amount paid by a guest who has used a room into a bank account of a corresponding room vendee based on sales and operation information of the hotel room, receiving a management fee from each vendee, calculating a sales amount of the room of the room vendee, and providing a result of calculating the sales amount of the room; and
a plurality of vendee terminals installed with an operation program connected to the operation server, for purchasing a desired room, and requesting and receiving sales and operation information and a result of calculating the sales amount of the room purchased by the vendee.

2. The system according to claim 1, further comprising: a room-selling server for providing the room vendee with the room-selling information related to the plurality of rooms of the hotel or the residence.

3. The system according to claim 1, wherein the operation server includes:
a data transmission and reception unit for transmitting and receiving data in association with the operation program;
an operation information input unit for receiving operation information of each room;
a control unit for controlling each component to calculate a sales amount of each room based on the inputted operation information and room-selling information;
a per-room sales amount calculation unit for calculating the sales amount of each room;
a room-selling information DB for storing the room-selling information of each room;
an operation information DB for storing detailed information on operation of the room;
a service provider DB for storing information on a service provider of the room vendee who has registered the purchased room; and
a member information DB for storing information on guest members of each service provider of the room.

4. The system according to claim 3, wherein the per-room sales amount calculation unit calculates a sales amount of each room so as to assign sales of a room generated at a specific unit to the room vendees in order.

5. The system according to claim 3, wherein the per-room sales amount calculation unit applies a different rental fee to each room and calculates a sales amount of each room so as to assign sales of a room to: a renter designated to a corresponding room depending on an occupancy rate and data on using the room based on a marketing result of each room.

6. The system according to claim 3, wherein the per-room sales amount calculation unit calculates a sales amount of each room so as to evenly split a total sales amount among renters by dividing the total sales amount generated at a specific unit by the number of rooms.

7. The system according to claim 1, wherein the service provider on a side of the plurality of vendee terminals who has purchased the room from the room-selling server of the investor or an offline room-selling agent registers as an individual service provider or a corporation service provider to launch sales of the room and protects the ownership or the right on the deposit by making an ownership registration or a rental registration, becomes an agent of the operation server and manages to directly deposit a sales income generated from the owned or rented hotel room into a bank account of the room vendee or the renter, i.e., an individual service provider, and pays a fixed fee and a variable fee of the hotel managed by the operating company as a rental fee and a contracted management fee on a basis of a contract unit such as a daily, weekly or monthly basis from a sales amount generated from the rooms of the vendee or the renter of each room registered as a service provider.

8. The system according to claim 1, wherein the purchase of the rooms is a rental purchase in which a rental period is set for the rented room, and the room vendee is the renter.

9. The system according to claim 1, wherein a method of operating the plurality of rooms of the hotel or the residence includes a method in which the service provider who has purchased the room through the operation server performs sales activities by himself or herself and sells the room that the vendee has purchased (hereinafter, referred to as a I check-in method), a method in which a regular price guest paying a regular room rate determined by the hotel or a discount price guest paying a discounted room rate is assigned by turns to an unoccupied hotel room that is not sold in the I check-in method (hereinafter, the method of checking in the regular price guest is referred to as a II-1 check-in method, and the method of checking in the discount price guest is referred to as a II-2 check-in method), and a method in which if a room vendee attracts guests in a day more than the rooms that the vendee has purchased, the guests are assigned with rooms of the other room vendees, and room charges are split based on a certain sales amount allocation rule (e.g., a rule of allocating the room charges to room vendees who have attracted the guests and room vendees who have allowed to use their rooms) (hereinafter, referred to as a III check-in method).

10. The system according to claim 9, wherein in the methods described above, when the II-1 check-in method or the II-2 check-in method should be used so that all the room vendees may receive same benefits, and if all the rooms are occupied in the I check-in method or the III check-in method, a guest is immediately assigned with a room in the II-1 check-in method or the II-2 check-in method when the room is unoccupied.

11. The system according to claim 9, wherein the II-1 check-in method or the II-2 check-in method may be divided into several check-in methods depending on a discount rate of: a discounted price so that all the room vendees may receive same benefits, in which the II-2 check-in method can be subdivided into a II-2-1 check-in method if the discount rate is 10%, a II-2-2 check-in method if the discount rate is 20%, a II-2-3 check-in method if the discount rate is 30%, and the like.

12. The system according to claim 9, wherein in the methods described above, when an unoccupied room is assigned to a guest in the II-1 check-in method of the regular price guest and the II-2 check-in method of the discount price guest, all the rooms are assigned by turns depending on the number of guests, with a cycle having a different starting point.

13. The system according to claim 12, wherein the II-2-1 check-in method, the II-2-2 check-in method and the II-2-3 check-in method also determine a starting room and assign a room to a guest as described above.

14. A method of selling a plurality of rooms and marketing and operating the rooms of a hotel, the method comprising the steps of:
(a) determining whether or not room-selling information of the rooms of the hotel or a residence is inputted and storing the inputted room-selling information in a room-selling information DB;
(b) determining whether or not operation information of the rooms is inputted from an operation program and storing the inputted operation information;
(c) depositing an amount paid by a guest who has used a room into a bank account of a corresponding room vendee based on the room-selling information and the operation information, receiving a management fee from each vendee, and calculating a sales amount of each room; and
(d) transmitting information on the calculated sales amount of each room to a corresponding room vendee.

15. The method according to claim 14, wherein if purchase of a room is made offline, step (a) inputs detailed room-selling information of the room, such as a purchase amount, a management fee and a rental fee (in a case of a rent), into the operation server of an operating company.

16. The method according to claim 14, wherein step (c) calculates a sales amount of each room so as to assign sales of a room generated at a specific unit to room vendees in order.

17. The method according to claim 14, wherein step (c) applies a different rental fee to each room and calculates a sales amount of each room so as to assign sales of a room to a designated renter depending on an occupancy rate and data on use of the room based on a marketing result of each room.

18. The method according to claim 14, wherein step (c) calculates a sales amount of each room so as to evenly split a total sales amount among renters by dividing the total sales amount generated at a specific unit by the number of rooms.

19. The method according to claim 14, wherein in step (c),
a method of operating the plurality of rooms of the hotel or the residence includes a method in which the service provider who has purchased the room through the operation server performs sales activities by himself or herself and sells the room that the vendee has purchased (hereinafter, referred to as a I check-in method), a method, in which a regular price guest paying a regular room rate determined by the hotel or a discount price guest paying a discounted room rate is assigned by turns to an unoccupied hotel room that is not sold in the I check-in method (hereinafter, the method of checking in the regular price guest is referred to as a II-1 check-in method, and the method of checking in the discount price guest is referred to as a II-2 check-in method), and a method in which if a room vendee attracts guests in a day more than the rooms that the vendee has purchased, the guests are assigned with rooms of the other room vendees, and room charges are split based on a certain sales amount allocation rule (e.g., a rule of allocating the room charges to room vendees who have attracted the guests and room vendees who have allowed to use their rooms) (hereinafter, referred to as a III check-in method).

20. The method according to claim 19, wherein in the methods described above, when the II-1 check-in method or the II-2 check-in method should be used so that all the room vendees may receive same benefits, and if all the rooms are occupied in, the I check-in method or the III check-in method, a guest is immediately assigned with a room in the II-1 check-in method or the II-2 check-in method when the room is unoccupied.

21. The method according to claim 19, wherein the II-1 check-in method or the II-2 check-in method may be divided into several check-in methods depending on a discount rate of a discounted price so that all the room vendees may receive same benefits, in which the II-2 check-in method can, be subdivided into a II-2-1 check-in method if the discount rate is 10%, a II-2-2 check-in method if the discount rate is 20%, a II-2-3 check-in method if the discount rate is 30% and the like.

22. The method according to claim 19, wherein in the methods described above, when an unoccupied room is assigned to a guest in the II-1 check-in method of the regular price guest and the II-2 check-in method of the discount price guest, all the rooms are assigned by turns depending on the number of rooms, with a cycle having a different starting point.

23. The method according to claim 22, wherein the II-2-1 check-in method, the II-2-2 check-in method and the II-2-3 check-in method also determine a starting room and as sign a room to a guest as described above.

24. A computer readable recording medium capable of recording, in a computer, a program for implementing a method of selling a plurality of rooms and marketing and operating the rooms of a hotel, the method comprising:
(a) a function of determining whether or not room-selling information of the rooms of the hotel or a residence is inputted and storing the inputted room-selling information in a room-selling information DB;
(b) a function of determining whether or not operation information of the rooms is inputted from an operation program and storing the inputted operation information;
(c) a function of depositing an amount paid by a guest who has used a room into a bank account of a corresponding room vendee based on the room-selling information and the operation information, receiving a management fee from each vendee, and calculating a sales amount of each room; and
(d) a function of transmitting information on the calculated sales amount of each room to a corresponding room vendee.
